(19) United States
(12) Patent Application Publication
(10) Pub. No.: US 2015/0123517 A1
(43) Pub. Date: May 7, 2015

(54) ROTARY ELECTRIC MACHINE AND BEARING CHANGING METHOD

(71) Applicant: Kenta Kaneko, Tokyo (JP)

(72) Inventor: Kenta Kaneko, Tokyo (JP)

(73) Assignee: Mitsubishi Electric Corporation, Chiyoda-ku, Tokyo (JP)

(21) Appl. No.: 14/398,097

(22) PCT Filed: Nov. 30, 2012
(86) PCT No.: PCT/JP2012/081206

§ 371 Date: Oct. 30, 2014

(30) Foreign Application Priority Data
May 29, 2012 (JP) 2012-121928

(51) Int. Cl. H02K 5/16; H02K 15/00; H02K 9/06

(52) U.S. Cl. CPC H02K 5/161; H02K 9/06; H02K 15/0006
USPC 310/60 R; 29/598

(57) ABSTRACT

A rotary electric machine includes a stator core; a rotor that includes a laminated core, core holders, and cooling fans; a frame that includes a tubular unit that encloses the stator core and the rotor, and a first bracket and a second bracket that extend in a direction of a rotor shaft and supports the rotor shaft; and cartridges that are detachably attached to the first bracket and the second bracket and rotatably support the rotor shaft, wherein groove-like holding portions, which hold end portions of bearing attaching and detaching jigs inserted through the first bracket and the second bracket, are provided in the cooling fans.

### FIELD

The present invention relates to a rotary electric machine that drives a railway vehicle and a bearing changing method.

### BACKGROUND

Typically, from the standpoint of reducing maintenance, totally-enclosed rotary electric machines are often used as rotary electric machines for railway vehicles. A totally-enclosed rotary electric machine is principally composed of a tubular frame, in which a rotor is arranged on its inner peripheral side, and housings, which are arranged facing each other at both ends of the frame and which rotatably support the rotor shaft. Bearings are provided in the central portion of the housings and a cylindrical stator core, which accommodates therein stator coils, is attached to the inner peripheral portion of the frame, and a uniform space is formed between the inner peripheral surface of the stator core and the outer peripheral surface of the rotor.

With a totally-enclosed rotary electric machine configured as above, although a cleaning operation of the rotor and the like is not necessary, periodic maintenance of the bearings is necessary. When the maintenance is performed, it is typical to first extract the rotor from the frame and thereafter detach the bearings.

As a method to eliminate such an operation, the traction motor illustrated in Patent Literature 1 described below is provided with rotor supporting devices, which are for supporting the rotor, and support receiving units, which receive the rotor supporting devices. The rotor is fixed by pressing the rotor supporting devices against the support receiving units by a plurality of bolts inserted from a bearing bracket side and thereafter the housings, which fix the bearings, are disassembled.

### CITATION LIST

### Patent Literature

Patent Literature 1: Japanese Patent Application Laid-open 2008-99491 (FIG. 1 and the like)

### SUMMARY

### Technical Problem

According to the above conventional technology, the rotor supporting devices are pressed against the support receiving units by bolts inserted from the bearing bracket. However, because the rotor is supported by the frictional force at the tip portions of the rotor supporting devices, there is a problem in that it is difficult to stably fix the rotor using only this frictional force. In this case, the axial center position of the rotor is displaced from the axial center position of the frame, which leads to a problem that the inner peripheral surface of the stator core and the outer peripheral surface of the rotor may come into contact with each other and thus may be damaged, and, moreover, it may become difficult to attach and detach the bearings. Moreover, according to the above conventional technology, because the rotor supporting devices and the support receiving units need to be provided near the bearing bracket and the housings, it is difficult to secure a space for cooling the bearings with a cooling fan. Furthermore, provision of the rotor supporting devices and the support receiving units increases the mass of the rotary electric machine.

The present invention is achieved in view of the above and has an object to obtain a rotary electric machine and a bearing changing method that can simplify the operation of attaching and detaching a bearing.

### Solution to Problem

In order to solve the above problems and achieve the object, the present invention includes a stator; a rotor that includes a rotor core that is arranged on an inner peripheral side of the stator and is formed by laminating magnetic steel sheets, a core holder that covers both ends of the rotor core, and a cooling fan that is attached to the core holder; a frame that includes a tubular unit that encloses the stator and the rotor, and a rotor shaft supporting unit that extends in a direction of a rotor shaft and supports the rotor shaft; and a bearing unit that is detachably attached to the rotor shaft supporting unit and rotatably supports the rotor shaft, wherein the cooling fan includes a main plate that is formed such that its diameter increases toward the bearing unit from the core holder, a groove-like or hole-like holding portion, in which an end portion of a bearing attaching and detaching jig inserted through the rotor shaft supporting unit is held, is provided in the main plate, and the main plate includes a thick portion that is thicker than a portion in which the holding portion is not provided.

### Advantageous Effects of Invention

According to the present invention, because the cooling fans are held by using the bearing attaching and detaching jigs, an effect is obtained where it is possible to simplify the operation of attaching and detaching the bearings.

### BRIEF DESCRIPTION OF DRAWINGS

FIG. 1 is a vertical cross-sectional view of a rotary electric machine according to a first embodiment of the present invention.

FIG. 2 is a diagram schematically illustrating bearing attaching and detaching jigs.

FIG. 3 is a diagram for explaining the shape of holding portions formed in cooling fans and the shape of end portions of the bearing attaching and detaching jigs.

FIG. 4 is a diagram illustrating a state where the bearing attaching and detaching jigs are attached to a first bracket and the bearing attaching and detaching jigs are attached to a second bracket.

FIG. 5 is a vertical cross-sectional view of a rotary electric machine according to a third embodiment of the present invention.

FIG. 6 is a diagram illustrating the side surface of a first bracket illustrated in FIG. 5.

### DESCRIPTION OF EMBODIMENTS

Exemplary embodiments of a rotary electric machine and a bearing changing method according to the present invention will be explained below in detail with reference to the drawings. This invention is not limited to the embodiments.

### First Embodiment

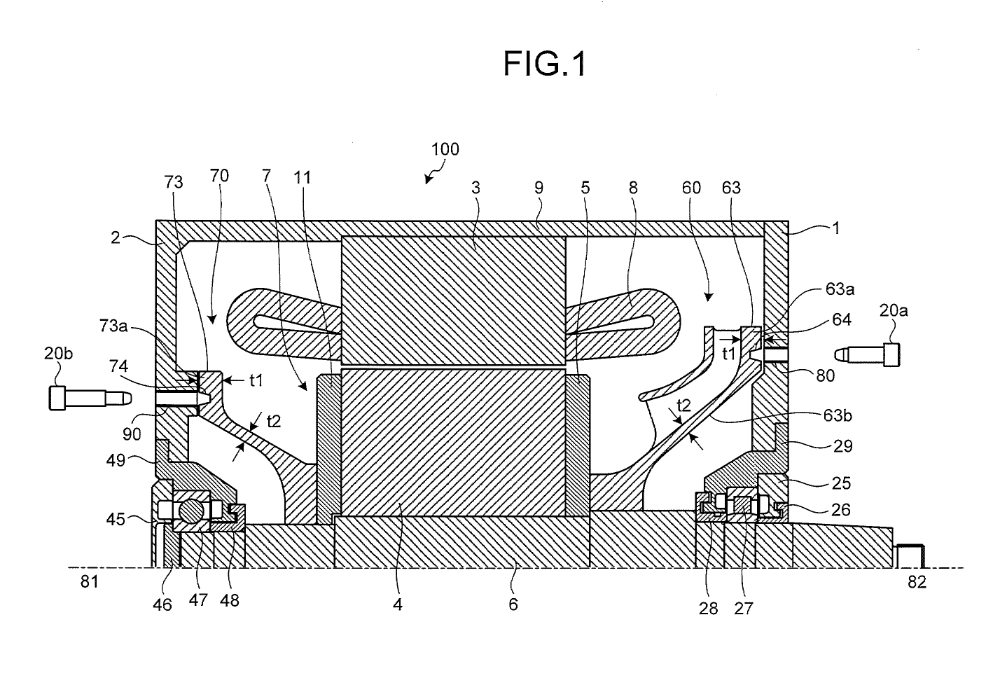

FIG. 1 is a vertical cross-sectional view of a rotary electric machine 100 according to the first embodiment of the present invention. In FIG. 1, the enclosed rotary electric machine 100 is illustrated as an example. The rotary electric machine 100 includes a stator core 3, a rotor 7, a tubular unit 9, a first bracket 1, a second bracket 2, a cartridge 29, and a cartridge 49. The first bracket 1 is arranged on a drive side 82 of the tubular unit 9 and the second bracket 2 is arranged on a counter drive side 81 of the tubular unit 9. The tubular unit 9, the first bracket 1, and the second bracket 2 form the frame of the rotary electric machine 100.

The cylindrical stator core 3, which accommodates therein stator coils 8, is attached to the inner peripheral portion of the tubular unit 9 and a uniform space is formed between the inner peripheral surface of the stator core 3 and the outer peripheral surface of a laminated core 4. With such a configuration, the torque of the rotor 7 is transmitted to a wheel via a coupling and gearing (both are not illustrated) arranged on the drive side 82.

Next, an explanation will be given of a cooling fan 60 arranged on the drive side 82 of the rotor 7 and a cooling fan 70 arranged on the counter drive side 81 of the rotor 7.

The rotor 7 includes the laminated core 4 formed by laminating magnetic steel sheets, a core holder 5 that covers the drive side 82 of the laminated core 4, and a core holder 11 that covers the counter drive side 81 of the laminated core 4. FIG. 1 illustrates the cooling fan 60 attached to the drive side 82 of the core holder 5 and the cooling fan 70 attached to the counter drive side 81 of the core holder 11.

In the cooling fan 60, a plurality of blades are formed for agitating the air in the rotary electric machine 100. The blades are provided to extend in the radial direction of the rotor 7 and are provided to stand at approximately equal intervals in the rotation direction of the rotor 7. A main plate 63 has a shape in which its diameter increases toward the cartridge 29 (bearing unit) from the core holder 5. The main plate 63 is provided with a through hole into which a rotor shaft 6 is inserted and holds one end of each blade. The shape of the cooling fan 60 is not limited to the shape illustrated in FIG. 1.

Furthermore, in the main plate 63, a groove-like holding portion 64 is circumferentially provided. The holding portion 64 holds end portions 13a of bearing attaching and detaching jigs 20a inserted through the first bracket 1 so that the cartridge 29 is attachable and detachable. For example, the main plate 63 is formed such that its outer peripheral end side extends along the first bracket 1 and includes a thick portion 63a that is thicker than a thin portion 63b in which the holding portion 64 is not provided. The thick portion 63a is formed such that a thickness t1 of the thick portion 63a is larger than a thickness t2 of the thin portion 63b. The holding portion 64 is formed on the surface of the thick portion 63a on the first bracket 1 side.

The cooling fan 70 is provided to extend in the radial direction of the rotor 7 for agitating the air around the bearing. A main plate 73 has a shape in which its diameter increases toward the cartridge 49 (bearing unit) from the core holder 11 and is provided with a through hole into which the rotor shaft 6 is inserted. The shape of the cooling fan 70 is not limited to the shape illustrated in FIG. 1.

Furthermore, in the main plate 73, a groove-like holding portion 74 is circumferentially provided. The holding portion 74 holds end portions 13b of bearing attaching and detaching jigs 20b inserted through the second bracket 2. For example, the main plate 73 is formed such that its outer peripheral end side extends along the second bracket 2 and includes a thick portion 73a that is thicker than a thin portion 73b in which the holding portion 74 is not provided. The thick portion 73a is formed such that a thickness t1 of the thick portion 73a is larger than a thickness t2 of the thin portion 73b. The holding portion 74 is formed on the surface of the thick portion 73a on the second bracket 2 side. “circumferentially provided” means providing the holding portion in an annular circle shape such that it is formed continuously along the circumferential direction or providing the holding portion in an annular circle shape such that part of the holding portion is interrupted.

With the cooling fan 60 and the cooling fan 70, when the rotor shaft 6 rotates, the air in the rotary electric machine 100 is agitated and the air heated by the rotor 7, the stator core 3, and the like is exchanged at the first bracket 1, the second bracket 2, the tubular unit 9, and the like, whereby the rotary electric machine 100 is efficiently cooled.

Next, the first bracket 1 and the cartridge 29 illustrated on the drive side 82 will be explained.

The cartridge 29 is provided on the axial center portion of the first bracket 1. The cartridge 29 is detachably fixed to the first bracket 1.

The cartridge 29 has a structure that is attachable and detachable from the drive side 82. The cartridge 29 accommodates therein a bearing 27 that rotatably supports one end of the rotor shaft 6 and includes a grease pocket for lubricating the bearing 27.

A bearing stopper 28 is provided on the rotor shaft 6. The bearing stopper 28 is arranged on the inner side of the machine relative to the bearing 27, positions the bearing 27, and forms a labyrinth structure together with the cartridge 29. The labyrinth refers to a structure that forms a boundary between the rotary portion and the stationary portion, prevents leakage of lubricating grease, and also prevents the entry of foreign matter from outside into the bearing 27 (including a bearing 47, which will be described later) and the rotary electric machine 100.

A bearing cap 25 is provided on the outer side of the machine relative to the bearing 27. The bearing cap 25 includes a grease pocket that retains lubricating grease supplied to the bearing 27 and forms a labyrinth structure together with a bearing stopper 26. The bearing cap 25 is detachably fixed by a fastening member (not illustrated) that is screwed toward the cartridge 29 from the outer side of the machine.

The bearing stopper 26 positions the bearing 27 and prevents leakage of lubricating grease to the outside of the machine by forming a labyrinth structure together with the bearing cap 25.

As described above, the labyrinth structure formed by the bearing cap 25, the bearing stopper 26, the cartridge 29, and the bearing stopper 28 can prevent leakage of lubricating grease to the outside of the machine.

Insertion holes 80, into which a plurality of the bearing attaching and detaching jigs 20a are inserted, are formed in the first bracket 1. Bolts (for example, bolts formed to have a length such that the tip portions thereof do not come into contact with the holding portion 64 provided in the main plate 63) shorter than the bearing attaching and detaching jigs 20a are screwed into the insertion holes 80 except when the bearing attaching and detaching jigs 20a are used. Accordingly, the bearing attaching and detaching jigs 20a are attached after these bolts are removed. FIG. 1 illustrates a state where the bearing attaching and detaching jigs 20a are inserted into the insertion holes 80.

Next, the second bracket 2 and the cartridge 49 illustrated on the counter drive side 81 will be explained.

The cartridge 49 is provided on the axial center portion of the second bracket 2. The cartridge 49 is detachably fixed to the second bracket 2.

The cartridge 49 has a structure that is attachable and detachable from the counter drive side 81. The cartridge 49 accommodates therein the bearing 47 that rotatably supports one end of the rotor shaft 6 and includes a grease pocket for lubricating the bearing 47.

A bearing stopper 48 is provided on the rotor shaft 6. The bearing stopper 48 is arranged on the inner side of the machine relative to the bearing 47, positions the bearing 47, and forms a labyrinth structure together with the cartridge 49.

A bearing cap 45 is provided on the outer side of the machine relative to the bearing 47. The bearing cap 45 includes a grease pocket that retains lubricating grease supplied to the bearing 47 and forms a labyrinth structure together with a bearing stopper 46. The bearing cap 45 is detachably fixed by a fastening member (not illustrated) that is screwed toward the cartridge 49 from the outer side of the machine.

The bearing stopper 46 positions the bearing 47 and prevents leakage of lubricating grease to the outside of the machine by forming a labyrinth structure together with the cartridge 49. The bearing stopper 46 is attached to the end portion of the rotor shaft 6.

As described above, the labyrinth structure formed by the bearing cap 45, the bearing stopper 46, the cartridge 49, and the bearing stopper 48 can prevent leakage of lubricating grease to the outside of the machine.

Insertion holes 90, into which a plurality of the bearing attaching and detaching jigs 20b are inserted, are formed in the second bracket 2. Bolts (for example, bolts formed to have a length such that the tip portions thereof do not come into contact with the holding portion 74 provided in the main plate 73) shorter than the bearing attaching and detaching jigs 20b are screwed into the insertion holes 90 except when the bearing attaching and detaching jigs 20b are used. Accordingly, the bearing attaching and detaching jigs 20b are attached after these bolts are removed. FIG. 1 illustrates a state when the bearing attaching and detaching jigs 20b are inserted into the insertion holes 90.

The distance from the center line of the rotor shaft 6 to the centers of the insertion holes 80 and 90 is set to be equal to the distance from the center line of the rotor shaft 6 to the centers of the holding portions 64 and 74.

Next, the shape of the bearing attaching and detaching jigs 20a and 20b will be explained.

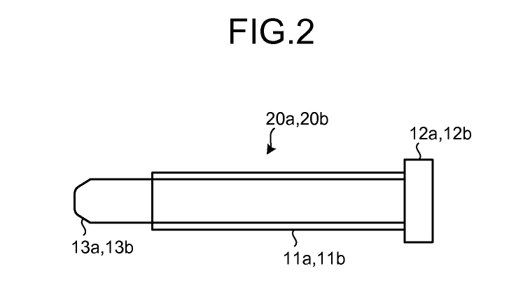

FIG. 2 is a diagram schematically illustrating the bearing attaching and detaching jigs 20a and 20b. The bearing attaching and detaching jigs 20a and 20b are jigs that, when the cartridges 29 and 49 are attached and detached, fix the rotor 7 without causing the laminated core 4 to come into contact with the stator core 3. The bearing attaching and detaching jigs 20a and 20b are attached to the first bracket 1 and the second bracket 2, respectively, to function as rotor supporting members. In order to prevent the axial center position of the rotor 7 from being displaced from the axial center position of the tubular unit 9, it is desirable to set the thickness of the bearing attaching and detaching jigs 20a and 20b in consideration of the weight of the rotor 7 and the like.

Externally threaded portions 11a and 11b are formed on the bearing attaching and detaching jigs 20a and 20b between bolt heads 12a and 12b and predetermined positions, respectively. The externally threaded portions 11a and 11b can be screwed into the insertion holes 80 and 90 formed in the first bracket 1 and the second bracket 2, respectively. Each of the predetermined positions is, for example, the length determined while taking the thickness of the first bracket 1 or the second bracket 2 into consideration.

The end portions 13a and 13b of the bearing attaching and detaching jigs 20a and 20b may be, for example, formed in a tapered shape that tapers toward the tips of the end portions 13a and 13b from the bolt heads 12a and 12b side, respectively, or formed in a rectangular shape.

Next, the relationship between the cross section of the end portions 13a and 13b and the cross section of the holding portions 64 and 74 will be specifically explained.

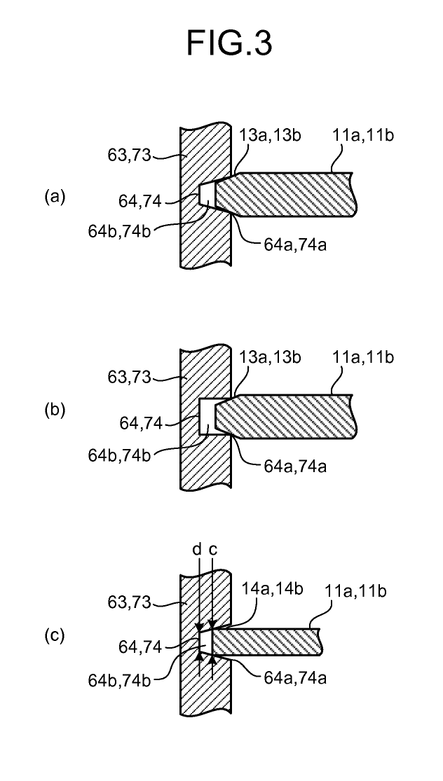

FIG. 3 is a diagram for explaining the shape of the holding portions 64 and 74 formed in the cooling fans 60 and 70, respectively, and the shape of the end portions 13a and 13b of the bearing attaching and detaching jigs 20a and 20b. FIG. 3 illustrates the cross section of the end portions 13a and 13b of the bearing attaching and detaching jigs 20a and 20b and the cross section (cross section along the radial direction of the rotor 7) of the holding portions 64 and 74 that hold the end portions 13a and 13b (end portions 14a and 14b), respectively.

The end portions 13a and 13b illustrated in FIG. 3(a) are formed in a tapered shape that tapers toward their tips, respectively. In a similar manner, the side surfaces of the holding portions 64 and 74 are also formed in a tapered shape such that the end portions of the bearing attaching and detaching jigs 20a and 20b can come into contact therewith. The taper angle of the holding portions 64 and 74 with respect to the longitudinal direction of the bearing attaching and detaching jigs 20a and 20b is an angle slightly smaller than the taper angle of the end portions 13a and 13b. If the taper angle of the end portions 13a and 13b is set larger than the taper angle of the holding portions 64 and 74 as described above, the rotor 7 can be fixed without causing the axial center position of the rotor 7 to be displaced from the axial center position of the tubular unit 9. Because the holding portions 64 and 74 and the end portions 13a and 13b are both formed in a tapered shape, for example, even if the main plates 63 and 73 are made of a lightweight material, such as aluminum, it is possible to prevent local deformation of the holding portions 64 and 74 (for example, deformation of top portions 64a and 74a of the holding portions 64 and 74). When the end portion 13a is held in the holding portion 64, a non-contact portion 64b is formed between the end portion 13a and the bottom surface of the holding portion 64. In a similar manner, when the end portion 13b is held in the holding portion 74, a non-contact portion 74b is formed between the end portion 13b and the bottom surface of the holding portion 74.

FIG. 3(b) illustrates an example where the cross-sectional shape of the holding portions 64 and 74 is changed. The end portions 13a and 13b illustrated in FIG. 3(b) are formed in a tapered shape in a similar manner to the end portions 13a and 13b illustrated in FIG. 3(a); however, the holding portions 64 and 74 are formed in a rectangular shape. Even when the end portions 13a and 13b are formed in a tapered shape and the holding portions 64 and 74 are formed in a rectangular shape as described above, the rotor 7 can be fixed without causing the axial center position of the rotor 7 to be displaced from the axial center position of the tubular unit 9, and the man-hours required for processing the holding portions 64 and 74 can be reduced. When the end portion 13a is held in the holding portion 64, the non-contact portion 64b is formed between the end portion 13a and the bottom surface of the holding portion 64. In a similar manner, when the end portion 13b is held in the holding portion 74, the non-contact portion 74b is formed between the end portion 13b and the bottom surface of the holding portion 74.

FIG. 3(c) illustrates an example where the cross-sectional shape of the end portions 14a and 14b is changed. The side surfaces of the holding portions 64 and 74 illustrated in FIG. 3(c) are formed in a tapered shape such that the end portions of the bearing attaching and detaching jigs 20a and 20b can come into contact therewith in a similar manner to the holding portions 64 and 74 illustrated in FIG. 3(a); however, the end portions 14a and 14b are formed in a rectangular shape. When the width of the tip portions of the end portions 14a and 14b is defined as c and the width of the bottom surfaces of the holding portions 64 and 74 is defined as d, the width c is formed to be larger than the width d. Even when the end portions 14a and 14b are formed in a rectangular shape and the holding portions 64 and 74 are formed in a tapered shape as described above, the rotor 7 can be fixed without causing the axial center position of the rotor 7 to be displaced from the axial center position of the tubular unit 9. When the end portion 14a is held in the holding portion 64, the non-contact portion 64b is formed between the end portion 14a and the bottom surface of the holding portion 64. In a similar manner, when the end portion 14b is held in the holding portion 74, the non-contact portion 74b is formed between the end portion 14b and the bottom surface of the holding portion 74.

The cross sectional shapes of the end portions 13a and 13b (or the end portions 14a and 14b) and the holding portions 64 and 74 illustrated in FIG. 3 are one example and they may also be configured as described below.

(1) First, an explanation will be given of a case where the end portions 13a and 13b are formed in a tapered shape. The end portions 13a and 13b are formed in a tapered shape such that the top portions 64a and 74a of the holding portions 64 and 74 can come into contact with the end portions 13a and 13b before the end portions 13a and 13b reach the bottom surfaces of the holding portions 64 and 74, respectively. (1a) In this case, the holding portions 64 and 74 may be formed such that the cross section along the radial direction of the rotor 7 has a tapered shape, (1b) or may be formed such that the cross section along the radial direction of the rotor 7 has a rectangular shape. The shape obtained by combining (1) and (1a) corresponds to FIG. 3(a) and the shape obtained by combining (1) and (1b) corresponds to FIG. 3(b).

(2) Next, an explanation will be given of a case where the holding portions 64 and 74 are formed in a tapered shape. The holding portions 64 and 74 are formed in a tapered shape such that the end portions 13a and 13b can come into contact with the side surfaces of the holding portions 64 and 74 before the end portions 13a and 13b reach the bottom surfaces of the holding portions 64 and 74, respectively. (2a) In this case, the end portions 13a and 13b may be formed in a rectangular shape (for example, the end portions 14a and 14b), (2b) or may be formed in a tapered shape. The shape obtained by combining (2) and (2a) corresponds to FIG. 3(c).

When the end portions 13a and 13b are formed in a round shape (curved shape), even if the main plates 63 and 73 are made of a material (such as aluminum) softer than the bearing attaching and detaching jigs 20a and 20b, the main plates 63 and 73 can be prevented from being damaged.

Next, the bearing changing method of the rotary electric machine 100 according to the first embodiment will be explained.

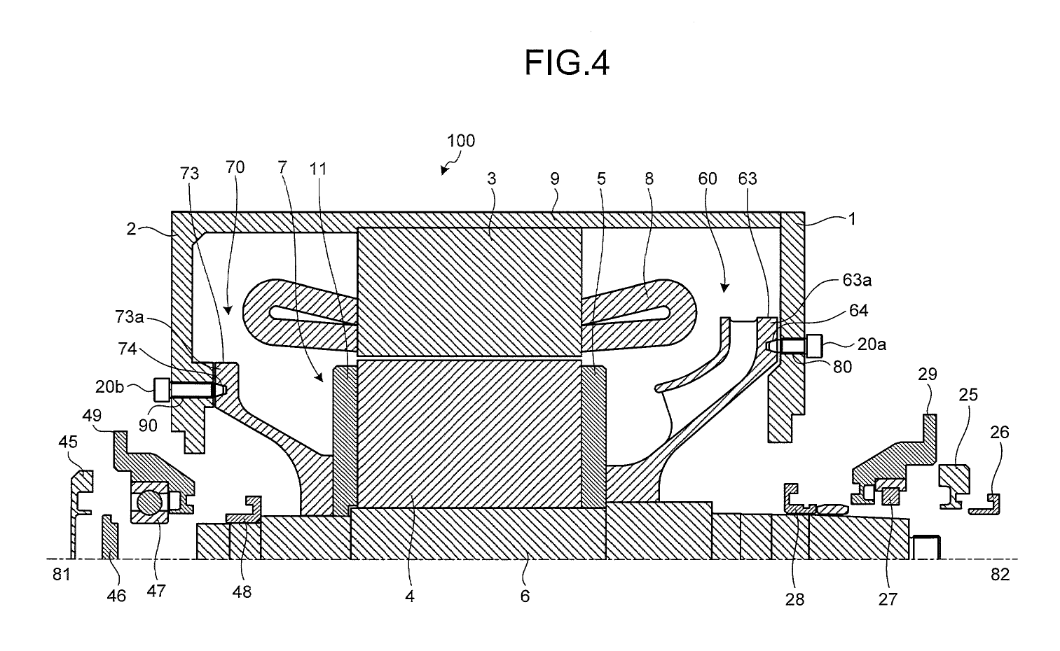

FIG. 4 is a diagram illustrating a state where the bearing attaching and detaching jigs 20a are attached to the first bracket 1 and the bearing attaching and detaching jigs 20b are attached to the second bracket 2. First, an operation of detaching the cartridges 29 and 49 will be explained. When the bearing attaching and detaching jigs 20a and 20b are inserted into the insertion holes 80 and 90, respectively, if a gap is generated between the end portions 13a and 13b and the holding portions 64 and 74, respectively, the axial center position of the rotor 7 may be displaced and the outer peripheral surface of the laminated core 4 may interfere with the inner peripheral surface of the stator core 3. In order to prevent such interference, it is desirable that the bearing attaching and detaching jigs 20a and 20b be screwed in until the end portions 13a and 13b thereof come into contact with the holding portions 64 and 74, respectively.

As illustrated in FIG. 4, when the end portions 13a and 13b of the bearing attaching and detaching jigs 20a and 20b are held in the holding portions 64 and 74, respectively, the cooling fans 60 and 70 are fixed by the bearing attaching and detaching jigs 20a and 20b, respectively. Accordingly, the rotor 7 is also fixed by the bearing attaching and detaching jigs 20a and 20b; therefore, even when the cartridges 29 and 49 are detached in this state, the laminated core 4 does not come into contact with the stator core 3.

On the drive side 82, the cartridge 29 can be detached by removing a fastening member (not illustrated). On the counter drive side 81, the cartridge 49 can be detached by removing a fastening member (not illustrated) in a similar manner.

Next, an explanation will be given of the operation of attaching the new cartridges 29 and 49 in which the bearings 27 and 47 and lubricating grease are changed. On the drive side 82, the cartridge 29 is attached to the first bracket 1, and, thereafter, the bearing attaching and detaching jigs 20a are detached from the insertion holes 80, and bolts (not illustrated) are screwed into the insertion holes 80. On the counter drive side 81, the cartridge 49 is attached to the second bracket 2, and, thereafter, the bearing attaching and detaching jigs 20b are detached from the insertion holes 90, and bolts (not illustrated) are screwed into the insertion holes 90.

It is desirable that the number of the bearing attaching and detaching jigs 20a and the number of the bearing attaching and detaching jigs 20b be three or more in order to stably fix the rotor 7. In this case, the number of the insertion holes 80 (the insertion holes 90) formed in the first bracket 1 (or the second bracket 2) is equal to or more than the number corresponding to the number of the bearing attaching and detaching jigs 20a (the bearing attaching and detaching jigs 20b), and the insertion holes 80 (the insertion holes 90) are arranged, for example, at equal intervals on a concentric circle centered on the axial center portion of the rotor shaft 6.

As explained above, the rotary electric machine 100 according to the first embodiment includes the stator core (stator) 3; the rotor 7 that includes the laminated core (rotor core) 4 that is arranged on the inner peripheral side of the stator core 3 and is formed by laminating magnetic steel sheets, the core holders 5 and 11 that cover both ends of the laminated core 4, and the cooling fans 60 and 70 that are attached to the core holders 5 and 11; the frame that includes the tubular unit 9 enclosing the stator core 3 and the rotor 7 and the rotor shaft supporting units (the first bracket 1 and the second bracket 2) that extend in a direction of the rotor shaft 6 and support the rotor shaft 6; and the cartridges (bearing units) 29 and 49 that are detachably attached to the rotor shaft supporting units (1, 2) and rotatably support the rotor shaft 6, wherein the cooling fans 60 and 70 include main plates 63 and 73 that are formed such that their diameters increase toward the bearing units (29, 49) from the core holders 5 and 11, the groove-like holding portions 64 and 74, in which the end portions 13a and 13b of the bearing attaching and detaching jigs 20a and 20b inserted through the rotor shaft supporting units (1, 2) are held, are provided in the main plates 63 and 73, and the main plates 63 and 73 include the thick portions 63a and 73a that are thicker than the portions in which the holding portions 64 and 74 are not provided. Therefore, when the cartridges 29 and 49 are attached and detached, the rotor 7 can be fixed in the radial direction (the radial direction of the rotor 7) simply by fastening the bearing attaching and detaching jigs 20a and 20b into the insertion holes 80 and 90, respectively. The clearance between the outer peripheral surface of the rotor 7 and the inner peripheral surface of the stator core 3 is typically about a few millimeters. Therefore, attachment and detachment of the cartridges 29 and 49 after extracting the rotor 7 from the tubular unit 9 should be done with extreme caution so that the outer peripheral surface of the rotor 7 does not come into contact with the inner peripheral surface of the stator core 3. In the conventional technology described above, the configuration is such that the rotor supporting devices and the like are provided near the bearing bracket and housings so as to simplify the operation of attaching and detaching the bearings. However, there are problems in that it is difficult to secure a space for cooling the bearings by using a cooling fan and the mass and cost of the rotary electric machine increases. The rotary electric machine 100 according to the first embodiment is such that the insertion holes 80 and 90 into which the bearing attaching and detaching jigs 20a and 20b are to be inserted are provided in the first bracket 1 (or the second bracket 2) and the groove-like holding portions 64 and 74 are provided in the cooling fans 60 and 70. Therefore, the rotor 7 can be fixed without using the rotor supporting devices and the like of the conventional technology and without substantially causing the axial center position of the rotor 7 to be displaced from the axial center position of the tubular unit 9.

Moreover, the rotor for a railway vehicle weighs, for example, about 100 kg in some cases; therefore, during maintenance of the bearings, it is necessary that the rotor supporting jig that supports the rotor 7 and the parts composing the holding portion have sufficient strength. Because it is not assumed that conventional electric machines are provided with such a holding portion in the main plate of the cooling fan, the main plate of a conventional electric machine is not provided with a thick portion that ensures sufficient strength. Consequently, when a holding portion is formed in the main plate of a conventional electric machine, stress is concentrated around the holding portion due to insufficient strength and thus the main plate may be deformed or a crack may be formed in the main plate. The main plates 63 and 73 according to the present embodiment include the thick portions 63a and 73a that are thicker than the portions in which the holding portions 64 and 74 are not provided; therefore, even when the rotary electric machine 100 in the present embodiment is applied to a motor for a railway vehicle, the stress concentrated in the holding portions 64 and 74 is relaxed and the necessary strength is provided. As a result, maintenance of the bearings can be performed in a stable state without the main plates 63 and 73 being deformed or a crack being formed in the main plates 63 and 73. Accordingly, the operation of attaching and detaching the bearings can be simplified and the bearing cooling space can be ensured. Furthermore, it is possible to manufacture a lighter rotary electric machine at a lower cost than conventional rotary electric machines.

Moreover, according to the rotary electric machine 100 in the first embodiment, it is not necessary to extract the rotor 7 from the tubular unit 9; therefore, for example, it is not necessary to use a crane to suspend the rotor 7 that is for a railway vehicle and weighs 100 kg or more, a special jig for disassembling the cartridges 29 and 49, and the like. Particularly, in the case of a permanent-magnet excited synchronous machine, the rotor 7 generates a strong magnetic force; therefore, when the rotor 7 is extracted from the tubular unit 9, the magnetic bodies around the rotary electric machine 100 during maintenance may be attracted to the rotor 7 and a repulsion force or an attractive force may be generated between the extracted rotor 7 and the tubular unit 9. According to the rotary electric machine 100 in the first embodiment, the cartridges 29 and 49 can be changed without such a risk.

Moreover, the groove-like holding portions 64 and 74 are provided along the circumferential direction of the cooling fans 60 and 70, respectively; therefore, the end portions 13a and 13b of the bearing attaching and detaching jigs 20a and 20b can be held without being limited by the position of the rotor 7 in the rotational direction.

Moreover, as illustrated in FIG. 3(a), the holding portions 64 and 74 according to the first embodiment are formed in a tapered shape such that the end portions 13a and 13b can come into contact with the side surfaces of the holding portions 64 and 74, respectively, and the non-contact portions 64b and 74b are formed between the end portions 13a and 13b and the bottom surfaces of the holding portions 64 and 74, respectively. With such a configuration, the rotor 7 can be fixed without causing the axial center position of the rotor 7 to be displaced from the axial center position of the tubular unit 9.

Moreover, as illustrated in FIG. 3(c), the holding portions 64 and 74 according to the first embodiment are formed in a tapered shape such that the end portions 14a and 14b can come into contact with the side surfaces of the holding portions 64 and 74, respectively, and the non-contact portions 64b and 74b are formed between the end portions 14a and 14b and the bottom surfaces of the holding portions 64 and 74, respectively. With such a configuration also, the rotor 7 can be fixed without causing the axial center position of the rotor 7 to be displaced from the axial center position of the tubular unit 9.

Moreover, the bearing attaching and detaching jigs 20a and 20b according to the first embodiment are formed into a bolt shape such that they are inserted into the rotor shaft supporting units (1, 2) and are held in the holding portions 64 and 74 provided in the cooling fans 60 and 70, respectively. Therefore, when the cartridges 29 and 49 are attached and detached, the rotor 7 can be fixed without causing the laminated core 4 to come into contact with the stator core 3, and, moreover, the bearing attaching and detaching jigs 20a and 20b can be manufactured by processing typical fastening members (such as bolts) and thus can be manufactured at low cost.

Moreover, the bearing changing method according to the first embodiment includes a jig attaching step of attaching the bearing attaching and detaching jigs 20a and 20b that are inserted into the rotor shaft supporting units (1, 2) and are held in the groove-like holding portions 64 and 74 provided in the cooling fans 60 and 70 to the rotor shaft supporting units (1, 2); a rotor fixing step of causing the holding portions 64 and 74 to hold the end portions 13a and 13b (the end portions 14a and 14b) of the bearing attaching and detaching jigs 20a and 20b and fixing the rotor 7 by screwing the bearing attaching and detaching jigs 20a and 20b into the rotor shaft supporting units (1, 2); and a bearing changing step of detaching the cartridges 29 and 49 from the rotor shaft supporting units (1, 2) and attaching the new cartridges 29 and 49 to the rotor shaft supporting units (1, 2). Therefore, when the cartridges 29 and 49 are attached and detached, the bearings 27 and 47 can be changed without causing the laminated core 4 to come into contact with the stator core 3 and easily compared with a method of the conventional technology.

Moreover, as illustrated in FIG. 3(a) and FIG. 3(b), the end portions 13a and 13b of the bearing attaching and detaching jigs 20a and 20b are formed in a tapered shape such that the top portions 64a and 74a of the holding portions 64 and 74 can come into contact with the end portions 13a and 13b before the end portions 13a and 13b reach the bottom surfaces of the holding portions 64 and 74, respectively. In this case, the holding portions 64 and 74 may be formed in a tapered shape as illustrated in FIG. 3(a) or may be formed in a rectangular shape as illustrated in FIG. 3(c). With such a configuration, the rotor 7 can be fixed without causing the axial center position of the rotor 7 to be displaced from the axial center position of the tubular unit 9.

### Second Embodiment

The rotary electric machine 100 according to the first embodiment is configured such that the bearing attaching and detaching jigs 20a and 20b are held by the holding portions 64 and 74 formed in the cooling fans 60 and 70, respectively. The rotary electric machine 100 according to the second embodiment is configured such that hole-like depressions (holding portions) that hold the bearing attaching and detaching jigs 20a and 20b are provided in the cooling fans 60 and 70 instead of the holding portions 64 and 74, respectively, and the bearing attaching and detaching jigs 20a and 20b are held by the hole-like holding portions. The rotary electric machine 100 according to the second embodiment is an embodiment in which the holding portions 64 and 74 illustrated in FIG. 1 are changed to hole-like holding portions. Therefore, in the following explanation, the rotary electric machine 100 according to the second embodiment is not illustrated in the drawings and the same portions as those in the first embodiment are denoted by the same reference numerals and an explanation thereof is omitted. In this embodiment, only different portions will be described.

In the cooling fans 60 and 70 according to the second embodiment, there is a plurality of hole-like holding portions described above that are provided on a concentric circle centered on the axial center portion of the rotor shaft 6. The number of the hole-like holding portions is not specifically limited; however, it is desirable to provide three or more hole-like holding portions in each of the cooling fan 60 and the cooling fan 70. In this case, it is desirable that the hole-like holding portions be arranged at equal intervals on a concentric circle centered on the axial center portion of the rotor shaft 6. Moreover, the number of the insertion holes 80 and 90 formed in the first bracket 1 (or the second bracket 2) is set to be equal to or more than a number corresponding to the number of the bearing attaching and detaching jigs 20a and 20b. Moreover, the insertion holes 80 and 90 are provided on a concentric circle centered on the axial center portion of the rotor shaft 6 and are arranged at intervals corresponding to those of the hole-like holding portions. Moreover, the distance from the center line of the rotor shaft 6 to the center of the insertion holes 80 and 90 is set to be equal to the distance from the center line of the rotor shaft 6 to the center of the hole-like holding portions.

Next, the bearing changing method of the rotary electric machine 100 according to the second embodiment will be explained.

First, an operation of detaching the cartridges 29 and 49 will be explained. When the bearing attaching and detaching jigs 20a and 20b are inserted into the insertion holes 80 and 90, respectively, if a gap is generated between the end portions 13a and 13b and the hole-like holding portions, respectively, the axial center position of the rotor 7 may be displaced and the outer peripheral surface of the laminated core 4 may interfere with the inner peripheral surface of the stator core 3. In order to prevent such interference, it is desirable that the bearing attaching and detaching jigs 20a and 20b be screwed in until the end portions 13a and 13b thereof come into contact with the hole-like holding portions, respectively.

When the end portions 13a and 13b of the bearing attaching and detaching jigs 20a and 20b are held in the hole-like holding portions, respectively, the cooling fans 60 and 70 are fixed by the bearing attaching and detaching jigs 20a and 20b, respectively. Accordingly, the rotor 7 is also fixed by the bearing attaching and detaching jigs 20a and 20b; therefore, even when the cartridges 29 and 49 are detached in this state, the laminated core 4 does not come into contact with the stator core 3.

On the drive side 82, the cartridge 29 can be detached by removing a fastening member (not illustrated). On the counter drive side 81, the cartridge 49 can be detached by removing a fastening member (not illustrated) in a similar manner. The operation of attaching the new cartridges 29 and 49 in which the bearings 27 and 47 and lubricating grease are changed is similar to that of the first embodiment; therefore, the explanation thereof is omitted.

It is desirable that the number of the bearing attaching and detaching jigs 20a and the number of the bearing attaching and detaching jigs 20b be three or more in order to stably fix the rotor 7. In this case, the number of the insertion holes 80 and 90 formed in the first bracket 1 (or the second bracket 2) is equal to or more than the number corresponding to the number of the bearing attaching and detaching jigs 20a and 20b, and the insertion holes 80 and 90 are arranged, for example, at equal intervals on a concentric circle centered on the axial center portion of the rotor shaft 6.

As explained above, the rotary electric machine 100 according to the second embodiment includes the stator core (stator) 3; the rotor 7 that includes the laminated core (rotor core) 4 that is arranged on the inner peripheral side of the stator core 3 and is formed by laminating magnetic steel sheets, the core holders 5 and 11 that cover both ends of the laminated core 4, and the cooling fans 60 and 70 that are attached to the core holders 5 and 11; the frame that includes the tubular unit 9 enclosing the stator core 3 and the rotor 7 and the rotor shaft supporting units (the first bracket 1 and the second bracket 2) that extend in a direction of the rotor shaft 6 and support the rotor shaft 6; and the cartridges (bearing units) 29 and 49 that are detachably attached to the rotor shaft supporting units (1, 2) and rotatably support the rotor shaft 6, wherein the cooling fans 60 and 70 include main plates 63 and 73 that are formed such that their diameters increase toward the bearing units (29, 49) from the core holders 5 and 11, the hole-like holding portions 64 and 74, in which the end portions 13a and 13b of the bearing attaching and detaching jigs 20a and 20b inserted through the rotor shaft supporting units (1, 2) are held, are provided in the main plates 63 and 73, and the main plates 63 and 73 include the thick portions 63a and 73a that are thicker than the portions in which the holding portions 64 and 74 are not provided. Therefore, the effect similar to that of the first embodiment can be obtained.

Moreover, because a plurality of hole-like holding portions are provided on a concentric circle centered on the axial center portion of the rotor shaft 6, the cost associated with the processing of the cooling fans 60 and 70 can be reduced compared with the case of circumferentially providing the groove-like holding portions 64 and 74.

Moreover, the hole-like holding portions according to the second embodiment are formed in a tapered shape such that the end portions 13a and 13b can come into contact with the side surfaces of the holding portions, respectively, and the non-contact portions 64b and 74b are formed between the end portions 13a and 13b and the bottom surfaces of the holding portions, respectively. With such a configuration, in a similar manner to the first embodiment, the rotor 7 can be fixed without causing the axial center position of the rotor 7 to be displaced from the axial center position of the tubular unit 9.

Moreover, the hole-like holding portions according to the second embodiment are formed in a tapered shape such that the end portions 14a and 14b can come into contact with the side surfaces of the hole-like holding portions, respectively, and the non-contact portions 64b and 74b are formed between the end portions 14a and 14b and the bottom surfaces of the hole-like holding portions, respectively. With such a configuration also, in a similar manner to the first embodiment, the rotor 7 can be fixed without causing the axial center position of the rotor 7 to be displaced from the axial center position of the tubular unit 9.

Moreover, the bearing attaching and detaching jigs 20a and 20b used in the rotary electric machine 100 according to the second embodiment are formed into a bolt shape such that they are inserted into the rotor shaft supporting units (1, 2) and are held in the hole-like holding portions provided in the cooling fans 60 and 70, respectively. Therefore, when the cartridges 29 and 49 are attached and detached, the rotor 7 can be fixed without causing the laminated core 4 to come into contact with the stator core 3, and, moreover, the bearing attaching and detaching jigs 20a and 20b can be manufactured at low cost.

Moreover, the bearing changing method applied to the rotary electric machine 100 according to the second embodiment includes a jig attaching step of attaching the bearing attaching and detaching jigs 20a and 20b that are inserted into the rotor shaft supporting units (1, 2) and are held in the hole-like holding portions formed in the cooling fans 60 and 70 to the rotor shaft supporting units (1, 2); a rotor fixing step of causing the hole-like holding portions to hold the end portions 13a and 13b (the end portions 14a and 14b) of the bearing attaching and detaching jigs 20a and 20b and fixing the rotor 7 by screwing the bearing attaching and detaching jigs 20a and 20b into the rotor shaft supporting units (1, 2); and a bearing changing step of detaching the cartridges 29 and 49 from the rotor shaft supporting units (1, 2) and attaching the new cartridges 29 and 49 to the rotor shaft supporting units (1, 2). Therefore, when the cartridges 29 and 49 are attached and detached, the cartridges 29 and 49 can be changed without causing the laminated core 4 to come into contact with the stator core 3 and easily compared with a method of the conventional technology.

Moreover, as illustrated in FIG. 3(a) and FIG. 3(b), the end portions 13a and 13b of the bearing attaching and detaching jigs 20a and 20b are formed in a tapered shape such that the top portions 64a and 74a of the hole-like holding portions can come into contact with the end portions 13a and 13b before the end portions 13a and 13b reach the bottom surfaces of the hole-like holding portions, respectively. In this case, the hole-like holding portions may be formed in a tapered shape in a similar manner to the holding portions 64 and 74 illustrated in FIG. 3(a), or may be formed in a rectangular shape in a similar manner to the holding portions 64 and 74 illustrated in FIG. 3(c). With such a configuration, the rotor 7 can be fixed without causing the axial center position of the rotor 7 to be displaced from the axial center position of the tubular unit 9.

### Third Embodiment

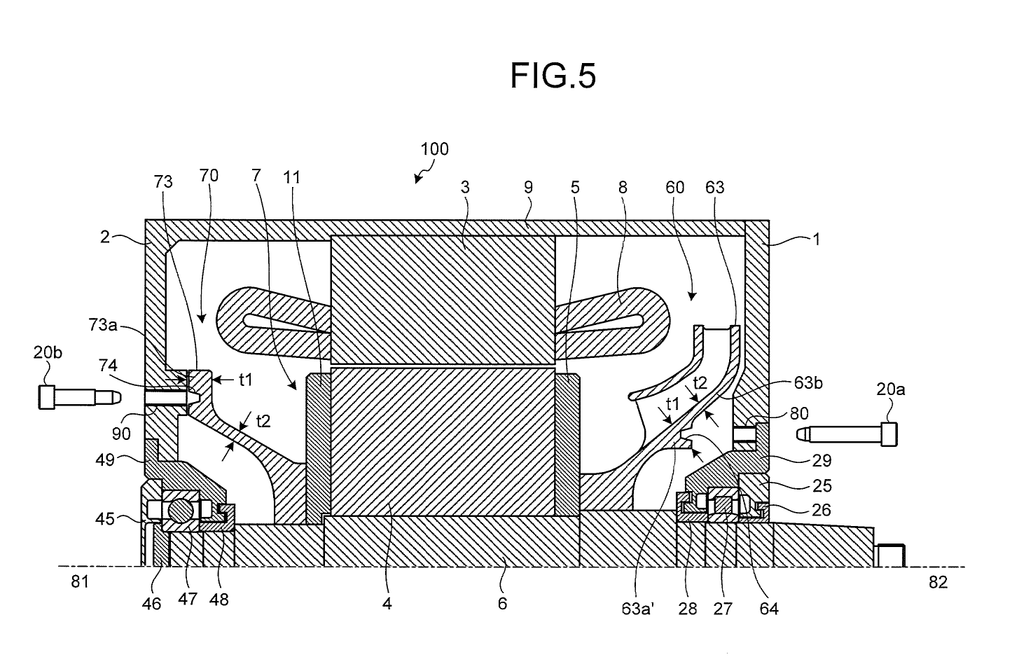

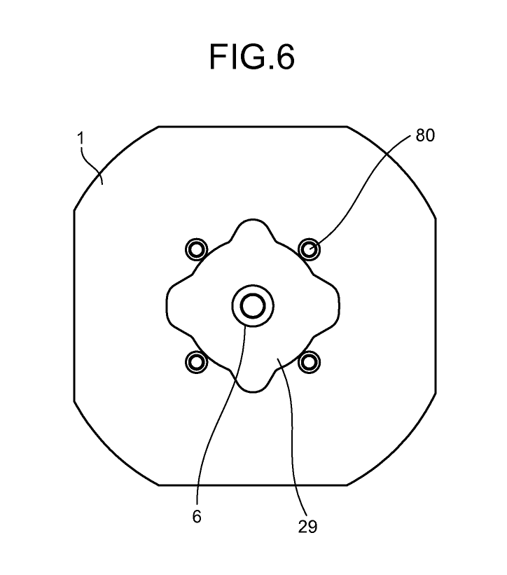

FIG. 5 is a vertical cross-sectional view of a rotary electric machine according to the third embodiment of the present invention. FIG. 6 is a diagram illustrating the side surface of the first bracket illustrated in FIG. 5. Hereinafter, the same portions as those in the first embodiment are denoted by the same reference numerals and an explanation thereof is omitted. In this embodiment, only different portions will be described.

In the main plate 63, the groove-like holding portion 64 is circumferentially provided. The holding portion 64 holds the end portions 13a of the bearing attaching and detaching jigs 20a inserted through the first bracket 1 so that the cartridge 29 is attachable and detachable. The main plate 63 is formed such that its outer peripheral end side extends along the first bracket 1 and includes a thick portion 63a′ that is thicker than the thin portion 63b in which the holding portion 64 is not provided. The thick portion 63a′ is formed such that a thickness t1 of the thick portion 63a′ is larger than a thickness t2 of the thin portion 63b. The holding portion 64 is formed on the surface of the thick portion 63a′ on the first bracket 1 side.

The cartridge 29 is provided on the axial center portion of the first bracket 1. The cartridge 29 is detachably fixed to the first bracket 1 by a fastening member (not illustrated) that is inserted toward the first bracket 1 from the drive side 82.

In the first bracket 1, the insertion holes 80, into which a plurality of the bearing attaching and detaching jigs 20a are inserted, are formed on the outer side with respect to the outer periphery of the cartridge 29. Bolts (for example, bolts formed to have a length such that the tip portions thereof do not come into contact with the holding portion 64 provided in the main plate 63) shorter than the bearing attaching and detaching jigs 20a are screwed into the insertion holes 80 except when the bearing attaching and detaching jigs 20a are used. Accordingly, the bearing attaching and detaching jigs 20a are attached after these bolts are removed.

Next, the bearing changing method of the rotary electric machine 100 according to the third embodiment will be explained. In this embodiment, only the method of changing the bearing on the drive side 82 will be explained and it is assumed that the method of changing the bearing on the counter drive side 81 is similar to that in the first embodiment and thus an explanation thereof is omitted.

First, when the cartridge 29 is removed, the bearing attaching and detaching jigs 20a are inserted into the insertion holes 80 and the bearing attaching and detaching jigs 20a are screwed in until the end portions 13a thereof come into contact with the holding portion 64. When the end portions 13a of the bearing attaching and detaching jigs 20a are held in the holding portion 64, the cooling fan 60 is fixed by the bearing attaching and detaching jigs 20a. Accordingly, the rotor 7 is also fixed by the bearing attaching and detaching jigs 20a. In this state, a fastening member (not illustrated) is removed and thereafter the cartridge 29 is removed. In this manner, the rotor 7 is fixed by the bearing attaching and detaching jigs 20a; therefore, even when the cartridge 29 is detached in this state, the laminated core 4 does not come into contact with the stator core 3.

Next, when the new cartridge 29 in which the bearing 27 and lubricating grease are changed is attached, the cartridge 29 is attached to the first bracket 1, and, thereafter, the bearing attaching and detaching jigs 20a are detached from the insertion holes 80. Then, bolts (not illustrated) are screwed into the insertion holes 80.

The cooling fan 60 according to the third embodiment can also be applied to the cooling fan on the counter drive side 81. In this case, the second bracket 2 includes insertion holes similar to the insertion holes 80 provided in the first bracket 1.

Instead of the groove-like holding portion 64, the hole-like holding portion in the second embodiment can also be applied to the cooling fan 60 according to the third embodiment.

As explained above, in the main plate 63 of the rotary electric machine 100 according to the third embodiment, the groove-like or hole-like holding portion 64, in which the end portions 13a of the bearing attaching and detaching jigs 20a inserted through the first bracket 1 are held, is provided, the main plate 63 includes the thick portion 63a′ that is thicker than the portion in which the holding portion 64 is not provided, and the thick portion 63a′ is formed on the center side of the main plate 63. Even when the rotary electric machine is configured as above, the effects similar to those of the first and second embodiments can be obtained. Moreover, the volume of the thick portion 63a′ can be reduced compared with the first embodiment; therefore, it is possible to manufacture a light rotary electric machine at a low cost.

In the explanation of the first to third embodiments, the first bracket 1, the second bracket 2, and the tubular unit 9 are configured as separate components; however, the rotary electric machine, the bearing attaching and detaching jigs, and the bearing changing method according to the first to third embodiment can also be applied to the rotary electric machine that includes a frame in which the first bracket 1, the second bracket 2, and the tubular unit 9 are integrated.

The structure in which the groove-like holding portions according to the first and third embodiment or the hole-like holding portions according to the second embodiment hold the bearing attaching and detaching jigs 20a and 20b may be applied only to the side of a cartridge (for example, the cartridge 29 on the drive side 82) that is expected to be changed more frequently. Even with such a configuration, when the cartridge 29 on the drive side 82 is detached, the rotor shaft 6 provided to extend toward the counter drive side 81 is supported by the bearing 47 arranged on the counter drive side 81; therefore, the workability in attachment and detachment of the cartridge 29 on the drive side 82 is not reduced. Moreover, it is not necessary to form the insertion holes 90 for the bearing attaching and detaching jigs 20b and the groove-like holding portion 74 or the hole-like holding portions provided on the second bracket 2 side; therefore, the processing cost can be reduced.

The bearing attaching and detaching jig 20a and the bearing attaching and detaching jig 20b may have lengths and diameters different from each other.

The bearing attaching and detaching jigs and the bearing changing method according to the first to third embodiments are not limited to the case of the totally-enclosed internal-fan-cooled rotary electric machine and, for example, can be used for a totally-enclosed external-fan-cooled rotary electric machine or the like.

The shape of the holding portions 64 and 74 according to the first to third embodiments is not limited to a tapered shape or a rectangular shape and may be formed in a round shape (curved shape). With such a shape, even if the bearing attaching and detaching jigs 20a and 20b are made of a material (such as aluminum) softer than the main plates 63 and 73, the bearing attaching and detaching jigs 20a and 20b can be prevented from being damaged.

The rotary electric machines 100 according to the first to third embodiments are an example of the content of the present invention and it goes without saying that they can be combined with other publicly known technologies and can be changed by, for example, omitting a part thereof without departing from the gist of the present invention.

### INDUSTRIAL APPLICABILITY

As described above, the present invention can be applied to a rotary electric machine, and is particularly useful as an invention that can simplify the operation of attaching and detaching a bearing.

### REFERENCE SIGNS LIST

1 first bracket (rotor shaft supporting unit), 2 second bracket (rotor shaft supporting unit), 3 stator core (stator), 4 laminated core (rotor core), 5 core holder, 6 rotor shaft, 7 rotor, 8 stator coil, 9 tubular unit, 11 core holder, 11a, 11b externally threaded portion, 12a, 12b bolt head, 13a, 13b end portion, 20a, 20b bearing attaching and detaching jig, 25 bearing cap, 26 bearing stopper, 27 bearing, 28 bearing stopper, 29 cartridge (bearing unit), 45 bearing cap, 46 bearing stopper, 47 bearing, 48 bearing cap, 49 cartridge (bearing unit), 60 cooling fan, 63 main plate, 63a, 63a′ thick portion, 63b thin portion, 64 holding portion, 64a top portion, 70 cooling fan, 73 main plate, 73a thick portion, 73b thin portion, 74 holding portion, 74a top portion, 80 insertion hole, 81 counter drive side, 82 drive side, 90 insertion hole, 100 rotary electric machine.

1. A rotary electric machine comprising:
a stator;
a rotor that includes
a rotor core that is arranged on an inner peripheral side of the stator and is formed by laminating magnetic steel sheets,
a core holder that covers both ends of the rotor core, and
a cooling fan that is attached to the core holder;
a frame that includes
a tubular unit that encloses the stator and the rotor, and
a rotor shaft supporting unit that extends in a direction of a rotor shaft and supports the rotor shaft; and
a bearing unit that is detachably attached to the rotor shaft supporting unit and rotatably supports the rotor shaft, wherein
the cooling fan includes a main plate that is formed such that its diameter increases toward the bearing unit from the core holder,
a groove-like or hole-like holding portion, in which an end portion of a bearing attaching and detaching jig inserted through the rotor shaft supporting unit is held, is provided in the main plate, and
the main plate includes a thick portion that is thicker than a portion in which the holding portion is not provided.

2. The rotary electric machine according to claim 1, wherein
the groove-like holding portion is provided along a circumferential direction of the cooling fan, and
a plurality of the hole-like holding portions are provided on a concentric circle centered on an axial center portion of the rotor shaft.

3. The rotary electric machine according to claim 1, wherein
a side surface of the holding portion is formed in a tapered shape such that the end portion of the bearing attaching and detaching jig is capable of coming into contact with the side surface of the holding portion, and
a non-contact portion is formed between the end portion and a bottom surface of the holding portion.

4. A bearing changing method of changing a bearing unit, which is applied to a rotary electric machine that includes a stator; a rotor that includes a rotor core that is arranged on an inner peripheral side of the stator and is formed by laminating magnetic steel sheets, a core holder that covers both ends of the rotor core, and a cooling fan that is attached to the core holder; a frame that includes a tubular unit that encloses the stator and the rotor, and a rotor shaft supporting unit that extends in a direction of a rotor shaft and supports the rotor shaft; and the bearing unit that is detachably attached to the rotor shaft supporting unit and rotatably supports the rotor shaft, and in which the cooling fan includes a main plate that is formed such that its diameter increases toward the bearing unit from the core holder, a groove-like or hole-like holding portion, in which an end portion of a bearing attaching and detaching jig inserted through the rotor shaft supporting unit is held, is provided in the main plate, and the main plate includes a thick portion that is thicker than a portion in which the holding portion is not provided, the bearing changing method comprising:
a jig attaching step of attaching the bearing attaching and detaching jig to the rotor shaft supporting unit;
a rotor fixing step of causing the holding portion to hold an end portion of the bearing attaching and detaching jig and fixing the rotor by screwing the bearing attaching and detaching jig into the rotor shaft supporting unit; and
a bearing changing step of detaching the bearing unit from the rotor shaft supporting unit and attaching a new bearing unit to the rotor shaft supporting unit.

5. The bearing changing method according to claim 4, wherein
the groove-like holding portion is provided along a circumferential direction of the cooling fan, and
a plurality of the hole-like holding portions are provided on a concentric circle centered on an axial center portion of the rotor shaft.

6. The bearing changing method according to claim 4, wherein the end portion of the bearing attaching and detaching jig is formed in a tapered shape such that a top portion of the holding portion is capable of coming into contact with the end portion before the end portion reaches a bottom surface of the holding portion.
